(19) United States
(12) Patent Application Publication
(10) Pub. No.: US 2003/0023653 A1
(43) Pub. Date: Jan. 30, 2003

(54) System, method and article of manufacture for a single-cycle floating point library

(76) Inventors: Andrew Dunlop, Oxford (GB); James J. Hrica, Los Gatos, CA (US)

Correspondence Address: CARLTON FIELDS, PA, P.O. BOX 3239, TAMPA, FL, 33601-3239, US

(21) Appl. No.: 09/772,524

(22) Filed: Jan. 29, 2001

(51) Int. Cl. G06F 7/38

(52) U.S. Cl. 708/551

(57) ABSTRACT

A system, method and article of manufacture are provided for improved efficiency during the execution of floating point applications. Initially, a floating point application is provided which includes a floating point library. Hardware is then built based on the floating point application. Computer code of the floating point application shares components selected from the group consisting of multipliers, dividers, adders and subtractors for minimizing an amount of the hardware to be constructed.

### FIELD OF THE INVENTION

The present invention relates to floating point applications and more particularly to providing improved efficiency during the execution of floating point applications.

### BACKGROUND OF THE INVENTION

It is well known that software-controlled machines provide great flexibility in that they can be adapted to many different desired purposes by the use of suitable software. As well as being used in the familiar general purpose computers, software-controlled processors are now used in many products such as cars, telephones and other domestic products, where they are known as embedded systems.

However, for a given function, a software-controlled processor is usually slower than hardware dedicated to that function. A way of overcoming this problem is to use a special software-controlled processor such as a RISC processor which can be made to function more quickly for limited purposes by having its parameters (for instance size, instruction set etc.) tailored to the desired functionality.

Where hardware is used, though, although it increases the speed of operation, it lacks flexibility and, for instance, although it may be suitable for the task for which it was designed it may not be suitable for a modified version of that task which is desired later. It is now possible to form the hardware on reconfigurable logic circuits, such as Field Programmable Gate Arrays (FPGA's) which are logic circuits which can be repeatedly reconfigured in different ways. Thus they provide the speed advantages of dedicated hardware, with some degree of flexibility for later updating or multiple functionality.

In general, though, it can be seen that designers face a problem in finding the right balance between speed and generality. They can build versatile chips which will be software controlled and thus perform many different functions relatively slowly, or they can devise application-specific chips that do only a limited set of tasks but do them much more quickly.

As is known in the art, a floating point number may be represented in binary format as an exponent and a mantissa. The exponent represents a power to which a base number such as 2 is raised and the mantissa is a number to be multiplied by the base number. Accordingly, the actual number represented by a floating point number is the mantissa multiplied by a quantity equal to the base number raised to a power specified by the exponent. In such a manner, any particular number may be approximated in floating point notation as f×B^{e} or (f,e) where f is an n-digit signed mantissa, e is an m-digit signed integer exponent and B is the base number system. In most computer systems, the base number system used is the binary number system where B=2, although some systems use the decimal number system (B=10) or the hexadecimal number system (B=16) as their base number system. Floating point numbers may be added, subtracted, multiplied, or divided and computing structures for performing these arithmetic operations on binary floating point numbers are well known in the art.

While floating point libraries have been established in the software domain, there is still a continuing need for effective handling of floating point numbers in hardware.

### SUMMARY OF THE INVENTION

A system, method and article of manufacture are provided for improved efficiency during the execution of floating point applications. Initially, a floating point application is provided which includes a floating point library. Hardware is then built based on the floating point application. Computer code of the floating point application shares components selected from the group consisting of multipliers, dividers, adders and subtractors for minimizing an amount of the hardware to be constructed.

In one embodiment of the present invention, the components are used on a single clock cycle. For example, the floating point library includes single-clock cycle macros for multiplication, add, subtract, negation, shifting, rounding, width conversion (float width 23 to float 32), and/or type conversion (float to int,etc.) operations. Multiple clock cycle macros are also provided for divide and square root operations.

In another embodiment of the present invention, a width of the output of the computer code may be user-specified. Width conversion can be done manually by calling a FloatConvert macro prior to the operation. As an option, it may be decided that all macros output results of the same width as the input in order to be consistent with integer operators. In one aspect of the present invention, the computer code may be programmed using Handel-C.

### BRIEF DESCRIPTION OF THE DRAWINGS

The invention will be better understood when consideration is given to the following detailed description thereof Such description makes reference to the annexed drawings wherein:

FIG. 1 is a schematic diagram of a hardware implementation of one embodiment of the present invention;

FIG. 2 illustrates a method by which Handel-C may be used for providing improved efficiency during the execution of floating point applications;

FIG. 3 illustrates a form of output including a structure, in accordance with one embodiment of the present invention;

FIG. 4 illustrates the Handel-C definitions that may be used for implementation of the present invention;

FIG. 5 illustrates various macros which may be used for implementation of the present invention; and

FIGS. 6-10 illustrate various tables delineating the performance of the present invention.

### DETAILED DESCRIPTION OF THE PREFERRED EMBODIMENTS

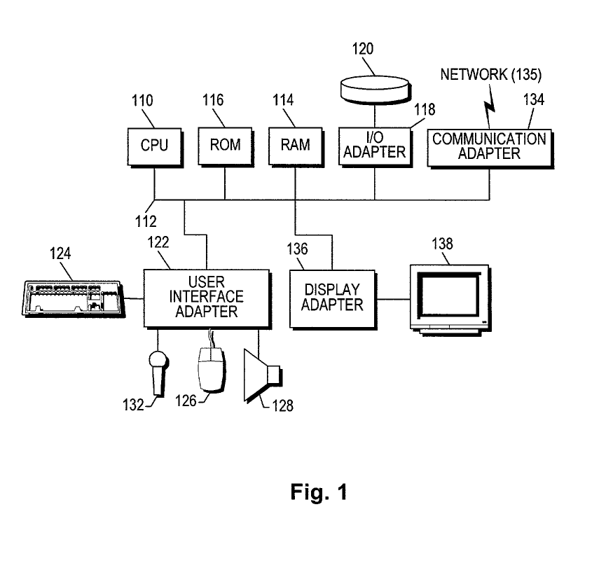

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

In one embodiment, the hardware environment of FIG. 1 may include, at least in part, a field programmable gate array (FPGA) device. For example, the central processing unit 110 may be replaced or supplemented with an FPGA. Use of such device provides flexibility in functionality, while maintaining high processing speeds.

Examples of such FPGA devices include the XC2000™ and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reprogrammable ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's' may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Typically, each of the many CLB's of an FPGA has at least one lookup table (LUT) that is user-configurable to define any desired truth table,—to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network is typically configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modem FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

Rather than determining with pencil and paper how each of the configurable resources of an FPGA device should be programmed, it is common practice to employ a computer and appropriate FPGA-configuring software to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

A popular class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D.TM. These serial CROP devices employ one-time programmable PROM (Programmable Read Only Memory) cells for storing configuration instructions in nonvolatile fashion.

A preferred embodiment is written using Handel-C. Handel-C is a programming language marketed by Celoxica Ltd. Handel-C is a programming language that enables a software or hardware engineer to target directly FPGAs (Field Programmable Gate Arrays) in a similar fashion to classical microprocessor cross-compiler development tools, without recourse to a Hardware Description Language. Thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a net list which can be placed and routed on a real FPGA.

More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” and “EMBEDDED SOLUTIONS Handel-C Preprocessor Reference Manual: Version 2.1,” each authored by Rachel Ganz, and published by Embedded Solutions Limited, and which are each incorporated herein by reference in their entirety. Additional information may be found in a co-pending application entitled “SYSTEM, METHOD AND ARTICLE OF MANUFACTURE FOR INTERFACE CONSTRUCTS IN A PROGRAMMING LANGUAGE CAPABLE OF PROGRAMMING HARDWARE ARCHITECTURES” which was filed under attorney docket number EMB1P041, and which is incorporated herein by reference in its entirety.

Another embodiment of the present invention may be written at least in part using JAVA, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided. OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each other's capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Bemers-Lee, D. Connoly, “RFC 1866: Hypertext Markup Language-2.0” (November 1995); and R. Fielding, H, Frystyk, T. Bemers-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

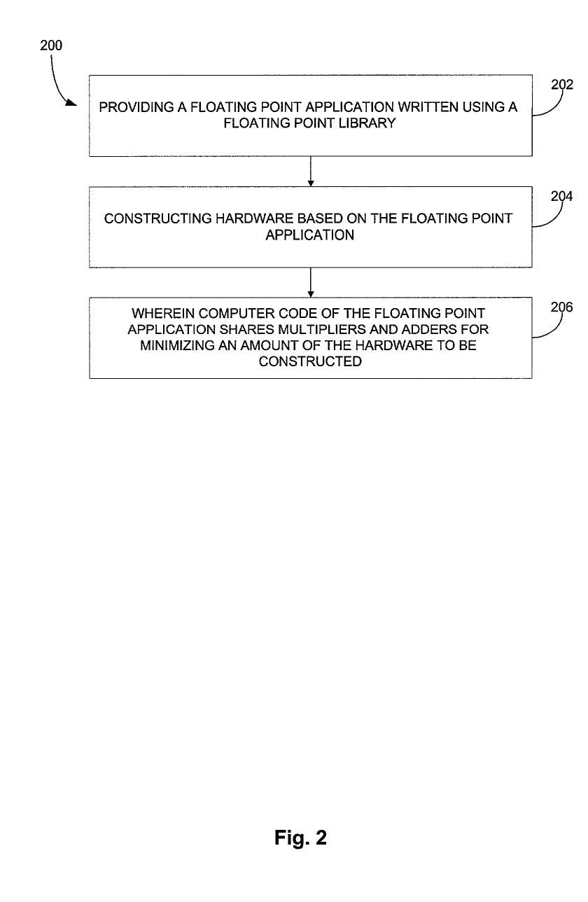

FIG. 2 illustrates a method 200 by which Handel-C may be used for providing improved efficiency during the execution of floating point applications. Initially, in operation 202, a floating point application is provided which includes a floating point library. Hardware is then built based on the floating point application. Note operation 204. Computer code of the floating point application shares multipliers and adders for minimizing an amount of the hardware to be constructed, as indicated in operation 206.

In one embodiment of the present invention, the components are used on a single clock cycle. To improve efficiency, the floating point library may include macros for arithmetic functions, integer to floating point conversions, floating point to integer conversions, and/or a square root function. As an option, a width of the output of the computer code may be user-specified, or handled using width conversion macros. More information regarding the manner in which the method of FIG. 2 may be implemented will now be set forth.

Hc2fpl.h (Handel-C version 2 Floating Point Library) is the Handel-C floating-point library for version 2.1. It contains macros for the arithmetic functions as well as some integer to floating point conversions and a square root macro. Table 1 illustrates the various features associated with Hc2fpl.h.

### Table 1

Contains single-cycle multiply, add and subtract macros.

Contains multi-cycle divide and square root macros

Include float-to-int and int-to-float converters.

Float-to-float width converters.

Caters for any width floating point number.

Widths of outputs can be specified to maintain precision.

There are two types of floating point macros for use by the programmer. If floating point usage is limited to single or double precision, the set width macros can be called in one of the ways set forth in Table 2. It should be noted that these macros are optional in an embodiment including a set of functions which cater for all widths.

### Table 2

result=hc2fpl_{—}mul_float(f1, f2);

result=hd2fpl_{—}add_double(f1, f2);

If extra intermediate precision and rounding is required, this can be activated by defining variables FLOAT_EXTRA_PREC or DOUBLE_EXTRA_PREC prior to including hc2fpl.h. It should be noted that the use of the FLOAT_EXTRA_PREC or DOUBLE_EXTRA_PREC variable may be avoided in the case where it is important to maintain consistency with Handel-C integer operators. In such embodiment, extra precision can be maintained by using FloatConvert to increase the width of the floating point number prior to the operation.

If one wishes a floating point word width to be anything other than 32 or 64 bit, more flexible macros must be used. These allow input variables of any width (up to a maximum significand width of 64), and they can output variables of a different width if required. It should be noted that there is little point outputting a number with more than double the significand width of the input values, as precision in a multiplication cannot increase by more than double. These macros take inputs of the two input floating point numbers, the significand width of the input values (swi), the significand width of the result (swr), and the total width of the result (twr). Note, for example, Table 2A.

### Table 2A

hc2fpl_{—}sub_{—}w or (f1, f2, swi, swr, twi);

or

FloatMult(f1, f2)

Table 3 illustrates the manner in which the macros are called. It should be noted that such macros are optional. Additional macros will be set forth hereinafter in greater detail.

### Table 3

result=hc2fpl_{—}mul_{—}w(f1, f2, 16, 24, 32),

where f1 and f2 are the input floating point values.

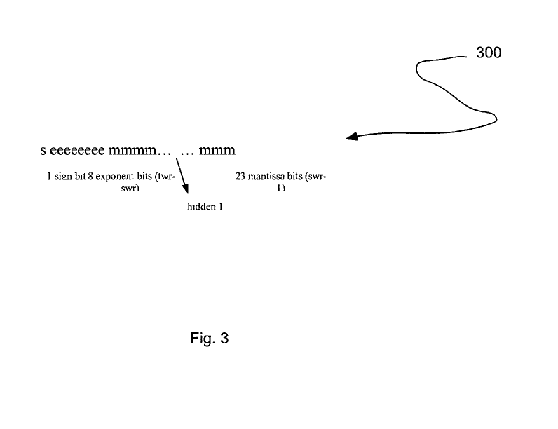

The third parameter (swi) is the significand width of the input values (f1 and f2), including the hidden 1. Parameter 4 (swr) is the significand width of the result, and the final parameter is the total width of the output value. FIG. 3 illustrates a form of output 300 including a structure, in accordance with one embodiment of the present invention. The floating point number is then stored in a structure containing a 1-bit wide unsigned integer sign bit, a width-parameterizable unsigned integer mantissa, and a parameterisable unsigned integer exponent. The widths of the exponent and mantissa are stated by the user on declaration.

The division and square-root macros are procedures, not expressions, and as a result they are not single cycle macros. These are called in a slightly different manner, with one of the input parameters eventually holding the result value. Note Table 4. Additional macros will be set forth hereinafter in greater detail.

### Table 4

hc2fpl_{—}div_{—}w(N, D, Q, swi, swr); OR FloatDiv(f1, f2

In Table 4, N is the numerator, d is the divisor, and Q is the quotient (the result value); swi and swr are, as before, the signific and widths of the input and result values, including the hidden 1. Once again, single-precision and double precision versions of these macros exist for convenience, and intermediate precision can be gained by defining FLOAT_EXTRA_PREC or DOUBLE_EXTRA_PREC. Again, it should be understood that the use of the FLOAT_EXTRA_PREC or DOUBLE_EXTRA_PREC variable may be avoided in the case where it is important to maintain consistency with Handel-C integer operators. In such embodiment, extra precision can be maintained by using FloatConvert to increase the width of the floating point number prior to the operation.

An extra floating point adder/subtractor is optionally included in the floating-point library. This adder is larger in size than the original adder, but can obtain faster clock speeds. This is useful for designs where speed is more important than hardware size.

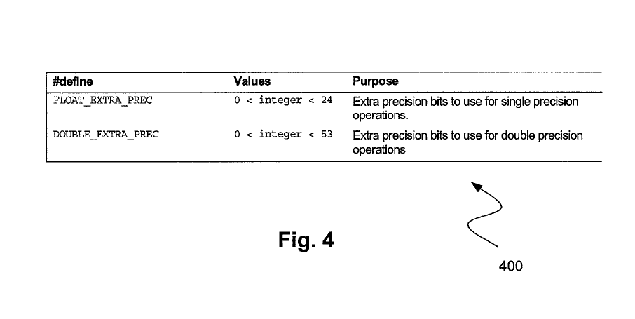

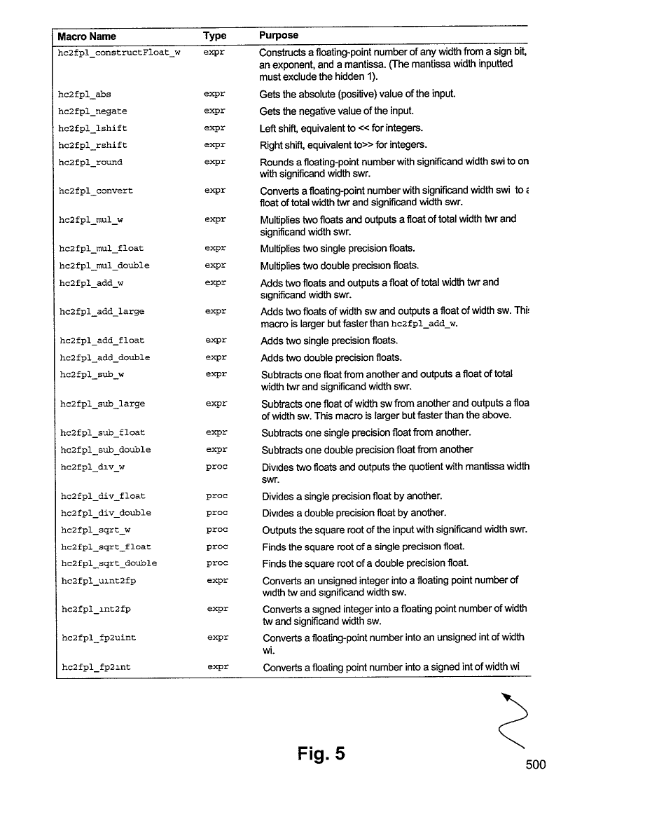

FIG. 4 illustrates the Handel-C definitions 400 that may be used for implementation of the present invention. FIG. 5 illustrates various macros 500 which may be used for implementation of the present invention.

To obtain maximum efficiency when writing Handel-C floating-point applications, it is advisable to share components selected from the group consisting of multipliers, dividers, adders and subtractors within computer code. See Table 5. This minimizes the amount of hardware built.

### Table 5

shared expr fMul1(a, b)=hc2fpl_{—}mul_{—}w(a, b, 14, 14, 20);

shared expr fMul2(a, b)=hc2fpl_{—}mul_{—}w(a, b, 14, 14, 20);

By doing this, only two multipliers will be built, so two multipliers may be used on any single clock cycle.

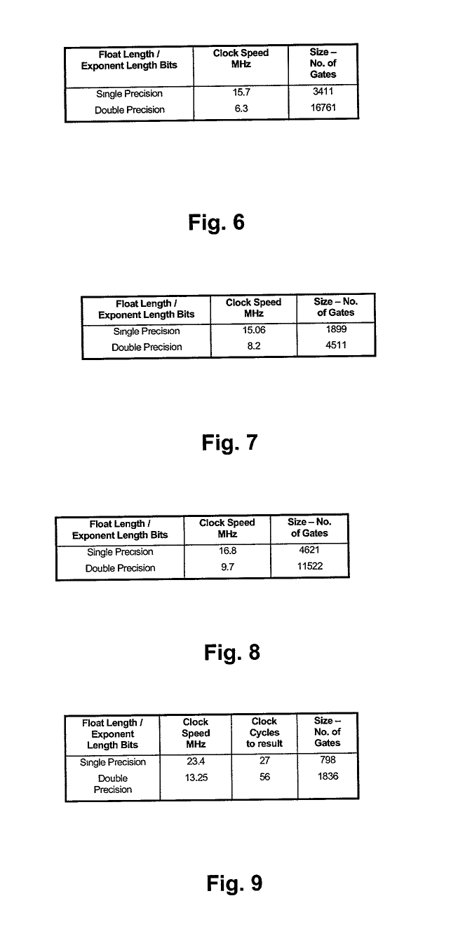

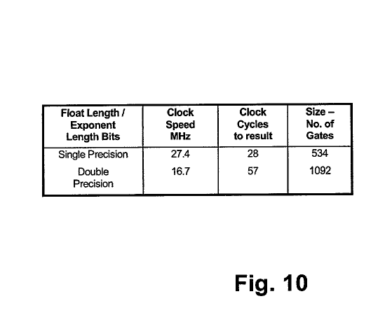

FIGS. 6-10 illustrate various tables delineating the performance of the present invention. It should be noted that such performances are minimal, and additional performance data will be set forth hereinafter in greater detail. Further, the tables show a relationship between size and clock speed. Such statistics may be used to determine an optimal number of components, i.e. adders and multipliers, to use.

Performance was tested by inputting from a tri-state pin interface, running the macro and outputting the result to the same pin interface. Running a trace after place and route gave a realistic application clock speed. The size is measured in number of Handel-C gates. It should be noted that the tables of FIGS. 6-10 are for a Xilinx Virtex V1000-6 FPGA component.

More information regarding various alternatives involving the present invention will now be set forth.

Floating Point Library

The Handel-C Floating Point Library provides floating-point support to applications written with the Handel-C development environment.

Features of the Floating Point Library according to a preferred embodiment include the following:

Zero-cycle addition, multiplication and subtraction.

Contains useful operators such as negation, absolute values, shifts and rounding.

Supports numbers of up to exponent width 15 and mantissa width 63.

Supports conversion to and from integers.

Provides square root functionality.

The Floating Point Library can be used to provide the following applications:

Floating precision DSP's.

Vector matrix computation.

‘Real World’ applications.

Any computation requiring precision.

In the Library, variables are kept in structures whose widths are defined at compile time. There are three parts to the structure; a single sign bit, exponent bits whose width is user defined upon declaration, and mantissa bits, also user defined. The ‘real’ value of the floating point number will be:

(−1)^{sign}.2^{(exponent-bias)}.(1.mantissa)

Where the bias depends on the width of the exponent.

In use, floating point variable widths are set by using declaration macros at compile time. Illustrative declaration macros are set forth below.

The library is used by calling one of the zero cycle macro expressions.

a=FloatAdd(b, c);

Multi-cycle macros are called in a different way.

FloatDiv(b, c, a);

The macros are not inherently shared; they are automatically expanded where they are called. If extensive use of some of the macros is required, it is advisable to share them in the following manner.

For zero-Cycle macros:

shared expr fmul_{—}1 (a, b)=FloatMult(a, b);

shared expr fmul_{—}2 (a, b)=FloatMult(a, b);

For multi-cycle macros:

void fdiv1 (FLOAT_TYPE *d, FLOAT_TYPE *n,

FLOAT_TYPE *q)

{

FloatDiv(*d, *n, *q);

}

There will now be defined two zero-cycle multipliers and one divider. All the usual precautions on shared hardware must now be taken.

The following tables provide performance statistics for various illustrative embodiments.

Altera Flex 10K30A FPGA.

| | | | Max |
|---|---|---|---|
| | Float Size | CLB | Clock |
| | (exp/mant) | Slices | Speed |
| FloatAdd | 6/16 | 1205 | 9.46 |
| FloatMult | 6/16 | 996 | 9.38 |
| FloatDiv | 6/16 | 390 | 22.02 |
| FloatSqrt | 6/16 | 361 | 18.21 |
| FloatAdd | 8/23 | 1328 | 6.53 |
| FloatMult | 8/23 | 1922 | 7.05 |
| FloatDiv | 8/23 | 528 | 16.80 |
| FloatSqrt | 8/23 | 505 | 13.47 |

Xilinx Virtex V1000-6 FPGA.

| | | | Max |
|---|---|---|---|
| | Float Size | CLB | Clock |
| | (exp/mant) | Slices | Speed |
| FloatAdd | 6/16 | 799 | 33.95 |
| FloatMult | 6/16 | 445 | 30.67 |
| FloatDiv | 6/16 | 348 | 39.61 |
| FloatSqrt | 6/16 | 202 | 32.93 |
| FloatAdd | 8/23 | 1113 | 33.95 |
| FloatMult | 8/23 | 651 | 28.79 |
| FloatDiv | 8/23 | 459 | 36.72 |
| FloatSqrt | 8/23 | 273 | 38.31 |

The program files that make up this Library and their purpose are set forth below.

| Filename | Purpose |
|---|---|
| Float.h | Prototypes the macros to the user |
| Float.lib | Stores the functionality of the library |

Illustrative macros that may be defined in the Handel-C code are presented in the following table.

| Macro Name | Type | Purpose |
|---|---|---|
| FLOAT | # define | Sets the widths of a Floating-point variable |
| FloatAbs | Macro | Returns absolute value of a Floating-point |
| | expression | number |
| FloatNeg | Macro | Returns negation of a Floating-point number |
| | expression | |
| FloatLeftShift | Macro | Left shifts a Floating-point number |
| | expression | |
| FloatRightShift | Macro | Right shifts a Floating-point number |
| | expression | |
| FloatRound | Macro | Rounds the mantissa of a Floating-point |
| | expression | number |
| FloatConvert | Macro | Changes a Floating-point number's width |
| | expression | |
| FloatMult | Macro | Multiplies two Floating-point numbers |
| | expression | together |
| FloatAdd | Macro | Adds two Floating-point numbers together |
| | expression | |
| FloatSub | Macro | Subtracts two Floating-point numbers from |
| | expression | each other |
| FloatDiv | Macro | Divides two Floating-point numbers |
| | procedure | |
| FloatSqrt | Macro | Finds the square root of a Floating-point |
| | procedure | number |
| FloatToUInt | Macro | Converts a Floating-point number to an |
| | expression | unsigned integer |
| FloatToInt | Macro | Converts a Floating-point number to a signed |
| | expression | integer |
| FloatFromUInt | Macro | Converts an unsigned integer to a Floating- |
| | expression | point number |
| FloatFromInt | Macro | Converts a signed integer to a Floating-point |
| | expression | number |

1.1.1.1 Software Development for the Floating-Point Library

This section specifies in detail the performance and functional specification of the design. Its purpose is to describe how requirements for implementation of the library are to be met. It also documents tests that can be used to verify that each macro functions correctly and that they integrate to work as one complete library.

The purpose of this design is to update an existing library to enable the user to perform arithmetic operations and integer to floating point conversions on floating point numbers in Handel-C.

About the Macros

Representation of a Floating Point Number.

A floating-point number is represented as a structure in the macros. The structure has three binary sections as to the IEEE 754 specifications.

Sign bit (unsigned int x.Sign)

Exponent (unsigned int x.Exponent)

Mantissa (unsigned int x.Mantissa)

In the library the structure of a floating-point number, say x, will be as follows:

x={x.Sign, x.Exponent, x.Mantissa}

This represents the number:

(−1)^{x.Sign}* (1.(x.Mantissa))*2^{(x.Exponent-bias)}

This expression can represent any decimal number within a range restricted by the exponent and mantissa width. Below is an example of how a floating-point number is defined.

#include <Float.h>

set clock=external “P1”;

typedef FLOAT(4, 6) Float_4_6;

void main( ) {

Float_4_6 x;

x={0, 9, 38}; }

First a structure type is chosen by stating the widths of the exponent and mantissa. The exponent is chosen to be of width 4 and the mantissa to be of width 6. This structure is named Float_4_6 and x is defined to be of this type.

x.Sign=0

This means that the number is positive.

x.Exponent=9

x.Exponent is unsigned but represents a signed number. To do this the exponent needs a correcting bias which is dependent on it's width.

Bias=2^{(Width of exponent-1)}−1

In this case as the exponent width is 4 then the bias is (2³−1)=7. The number 9 therefore means the multiplying factor is 2⁽⁹⁻⁷⁾=2²=4.

x.Mantissa=38

The mantissa represents the decimal places of the number. As x.Mantissa=38=100110 then this represents the binary number 1.100110 in the equation. In decimal this is 1.59375. The one added to this number is known as a hidden 1.

The floating point number represented by {0,9,38} is:

(−1)⁰(1.59375)(4)=6.375

IEEE Width Specifications.

The widths of the exponent and mantissa have certain set specifications.

IEEE 754 Single Precision

Exponent is 8 bits and has a bias of 127

Mantissa is 23 bits not including the hidden 1.

IEEE 754 Double Precision

Exponent is 11 bits and has a bias of 1023

Mantissa is 52 bits not including the hidden 1.

IEEE 754 Extended Precision

Exponent is 15 bits and has a bias of 32767

Mantissa is 64 bits not including the hidden 1.

The precision types can be requested by specifying these Exponent and Mantissa widths for the floating point number.

Valid Floating-point Numbers.

For the purposes of this section a valid floating-point number is one of Exponent width less than 16 and Mantissa width less than 64. The Exponent and Mantissa are any bit pattern inside those widths which includes the special bit patterns. This library is tested up to this level.

Single Cycle Expressions.

Most of the library utilities are zero cycle macro expressions and so use a single cycle when part of an assignment. They allow input variables of any width (up to a maximum mantissa width of 63). They will however only be tested up to a precision which is 1 sign bit, 15 exponent bits and 63 mantissa bits.

An example of a single cycle expression is the subtraction utility. This macro takes two floating-point numbers, f1 and f2 of the same structure type.

result=FloatSub(f1, f2)

Result would then be a floating-point number with the same structure type as f1 and f2.

Division and Square Root Macros.

The only utilities implemented as macro procedures (which are not single cycle expressions) are the division and square-root macros. These are called in a slightly different manner, with one of the input parameters eventually holding the result value. For example, the division macro is defined as:

FloatDiv(N, D, Q);

The parameters for all these functions are:

N floating point numerator.

D floating point divisor.

Q floating point quotient (the result value).

N and D are unchanged after the macro is completed.

Special Values.

Special bit pattern are recognized in the library. These are referred to as Not a Number (NaN) and infinity.

NaN

NaN is represented by all 1's in the exponent and any non-zero pattern in the mantissa. Following is an example of a single precision NaN in binary.

x.Sign=0

x.Exponent=11111111

x.Mantissa=00000000000000000000001

Infinity

Infinity is represented by all 1's in the exponent and all 0's in the mantissa. This is the only way the single precision infinity can be represented in binary.

x.Sign=0

x.Exponent=11111111

x.Mantissa=00000000000000000000000

Output When Errors Occur.

When an error occurs in the calculation a special bit pattern is output as error messages. The bit pattern that is produced depends on the situation. Several illustrative bit patterns are set forth below. Underflow is not strictly an error, but it is included below for reference.

| Problem | | Where problem | |
|---|---|---|---|
| number | Problem | occurs | Output |
| 1 | Input Infinity | Input | Infinity |
| 2 | Overflow | Result | Infinity |
| 3 | x/0, x != 0 | Input | Infinity |
| 4 | Input NaN | Input | NaN (Mantissa: Same as |
| | | | input) |
| 5 | 0 * Infinity | Input | NaN (Mantissa: 1) |
| 6 | 0/0 | Input | NaN (Mantissa: 2) |
| 7 | sqrt(x), x < 0 | Input | NaN (Mantissa: 3) |
| 8 | Infinity + (−Infinity) | Input | NaN (Mantissa: 4) |
| 9 | Infinity/Infinity | Input | NaN (Mantissa: 5) |
| 10 | Underflow | Result | 0 |
| 11 | sqrt(−0) | Input | −0 |

Macro Definitions.

For each of the following macros all input and result floating-point numbers have the same structure type.

Structure

ID: Structure 1

Prototype: #define FLOAT(ExpWidth, MantWidth) float_Name

Description.

Defines a structure called float_Name with an unsigned integer part called Sign (of width 1), unsigned integer part called Exponent (of width ExpWidth) and unsigned integer part called Mantissa (with width MantWidth).

| Parameters | Description | Range |
|---|---|---|
| ExpWidth | The width of the exponent | (1-15) |
| MantWidth | The width of the mantissa | (1-63) |

Absolute Value.

ID: Function 1

Prototype: FloatAbs(x)

Description.

Returns the absolute (positive) value of a floating point number.

Possible Error.

None.

| Parameters | Description | Range |
|---|---|---|
| x | Floating-point Number | Any valid F.P. number |

Negation.

ID: Function 2

Prototype: FloatNeg(x)

Description.

Returns the negated value of a floating point number.

Possible Error.

Negating zero returns a zero.

| Parameters | Description | Range |
|---|---|---|
| x | Floating-point Number | Any valid F.P. number |

Left Shift.

ID: Function 3

Prototype: FloatLeftshift(x, v)

Description.

Shifts a floating-point number by v places to the left. This macro is equivalent to << for integers.

Possible Error.

1, 2 & 4.

Example.

Single precision representation of 6 left shifted by 4.

(−1)⁰(1+0.5)* 2⁽¹²⁹⁻¹²⁷⁾<<4=(−1)⁰(1+0.5)*2⁽¹³³⁻¹²⁷⁾

The result is the representation of 96 or 6*2⁴.

| Parameters | Description | Range |
|---|---|---|
| x | Floating-point Number | Any valid F.P. |
| | | number |
| v | Amount to shift by. | Unsigned integer |
| | | (0-width(x)) |

Right Shift.

ID: Function 4

Prototype: FloatRightShift(x, v)

Description.

Shifts a floating-point number by v places to the right. This macro is equivalent to >> for integers.

Possible Error.

1, 4 & 10.

| Parameters | Description | Range |
|---|---|---|
| x | Floating-point Number | Any valid F.P. |
| | | number |
| v | Amount to shift by. | Unsigned integer |
| | | (0-width(x)) |

Nearest Rounding.

ID: Function 5

Prototype: FloatRound(x, MantWidth)

Description.

Rounds a floating-point number to have mantissa width Mantwidth. The value MantWidth must be less than the original mantissa width or else the macro won't compile.

Possible Errors.

1 & 4.

| Parameters | Description | Range |
|---|---|---|
| x | Floating-point number of any width | Any valid F.P. |
| | | number |
| MantWidth | Mantissa width of the result | Unsigned integer |
| | | (1 . . . 63) |

Conversion Between Widths.

ID: Function 6

Prototype: FloatConvert(x, ExpWidth, MantWidth)

Description.

Converts a floating-point number to a float of exponent width ExpWidth and mantissa width MantWidth.

Possible Errors.

1, 2 & 4.

| Parameters | Description | Range |
|---|---|---|
| x | Floating-point number of any width | Any valid F.P. |
| | | number |
| ExpWidth | Exponent width of the result | Unsigned integer |
| | | (1 . . . 15) |
| MantWidth | Mantissa width of the result | Unsigned integer |
| | | (1 . . . 63) |

Multiplier.

ID: Function 7

Prototype: FloatMult(x1, x2)

Description.

Multiplies two floating point numbers of matching widths.

Possible Errors.

1, 2, 4, 5 & 10.

| Parameters | Description | Range |
|---|---|---|
| x1, x2 | Floating-point numbers | Any valid F.P. |
| | | number |

Addition.

ID: Function 8

Prototype: FloatAdd(x1, x2)

Description.

Adds two floating point numbers of matching widths.

Possible Errors.

1, 2, 4 & 8.

| Parameters | Description | Range |
|---|---|---|
| x1, x2 | Floating-point numbers | Any valid F.P. |
| | | number |

Subtraction.

ID: Function 9

Prototype: FloatSub(x1, x2)

Description.

Subtracts two floating-point numbers of matching widths (x1−x2).

Possible Errors.

1, 2, 4 & 8.

| Parameters | Description | Range |
|---|---|---|
| x1, x2 | Floating-point numbers | Any valid F.P. |
| | | number |

Division.

ID: Function 10

Prototype: FloatDiv(N, D, Q)

Description.

Divides two floating-point numbers of matching widths and outputs the quotient. N/D=Q

Possible Errors.

1, 2, 3, 4, 6, 9 & 10.

| Parameters | Description | Range |
|---|---|---|
| N, D | Input floating-point numbers | Any valid F.P. |
| | | number |
| Q | Output floating-point | Any valid F.P. |
| | number = N/D | number |

Square Root.

ID: Function 11

Prototype: FloatSqrt(R, Q)

Description.

Square roots a floating-point number. Sqrt(R)=Q

Possible Errors.

1, 4, 7, 10 & 11.

| Parameters | Description | Range |
|---|---|---|
| R | Input floating-point number | Any valid F.P. |
| | | number |
| Q | Output floating-point | Any valid F.P. |
| | number = Sqrt(R) | number |

Floating Point to Unsigned Integer Conversion.

ID: Function 12

Prototype: FloatToUInt(x, wi)

Description.

Converts a floating-point number into an unsigned integer of width wi using truncation rounding. If the number is negative a zero is returned.

Possible Errors.

1 & 4.

| Parameters | Description | Range |
|---|---|---|
| x | Floating-point number | Any valid F.P. |
| | | number |
| wi | Total width of the result | Any unsigned integer |

Floating Point to Signed Integer Conversion.

ID: Function 13

Prototype: FloatToInt(x, wi)

Description.

Converts a floating point number into a signed integer of width wi using truncation rounding.

Possible Errors.

1 & 4.

| Parameters | Description | Range |
|---|---|---|
| x | Floating-point number | Any valid F.P. |
| | | number |
| wi | Total width of the result | Any signed integer |

Unsigned Integer to Floating Point Conversion.

ID: Function 14

Prototype: FloatFromUInt(u, ExpWidth, MantWidth)

Description.

Converts an unsigned integer into a floating point number of exponent width ExpWidth and mantissa width MantWidth using truncation rounding.

Possible Errors.

2.

| Parameters | Description | Range |
|---|---|---|
| u | Unsigned integer | Any unsigned integer |
| ExpWidth | Exponent width of the result | Unsigned integer |
| | | (1 . . . 63) |
| MantWidth | Mantissa width of the result | Unsigned integer |
| | | (1 . . . 15) |

Signed Integer to Floating Point Conversion.

ID : Function 15

Prototype FloatFromInt(i, ExpWidth, MantWidth)

Description.

Converts a signed integer into a floating point number of exponent width ExpWidth and mantissa width MantWidth using truncation rounding.

Possible Errors.

2.

| Parameters | Description | Range |
|---|---|---|
| i | Integer | Any integer |
| ExpWidth | Exponent width of the result | Unsigned integer |
| | | (1 . . . 63) |
| MantWidth | Mantissa width of the result | Unsigned integer |
| | | (1 . . . 15) |

Detailed Design

The following subsections describe design specifications for practicing various embodiments of the present invention.

Interface Design

Structure 1—FLOAT(ExpWidth, MantWidth) Float_Name

Description.

Defines a structure called Float_Name with an unsigned integer part called Sign (of width 1), an unsigned integer part called Exponent (of width ExpWidth) and an unsigned integer part called Mantissa (with width MantWidth).

Valid floating-point Numbers.

For the purposes of this document a valid floating-point number is one of ExpWidth less than 16 and MantWidth less than 65. The Exponent and Mantissa are any bit pattern inside those widths including the special bit patterns. The library will be tested up to this level.

Input.

ExpWidth—The width of the exponent.

MantWidth—The width of the mantissa.

Output.

Format of the structure:

struct
{

unsigned int 1 Sign;
unsigned int ExpWidth Exponent;
unsigned int MantWidth Mantissa;

}float_Name;

Component Detail Design

Explanation of the Detailed Description.

If a variable isn't mentioned then it is the same on output as input. For ease of understanding, the operations on each component have ach been provided with a header.

Each macro tests if the input is infinity or NaN before it does the stated calculations. If the input is invalid the same floating-point number is output. This can be done by:

if Exponent=−1

{

x=x

}

else

{

x=Calculation

}

Some of the library macros call upon other macros unseen by the user. These are listed in each section along with a brief description as to their use under the title

“Dependencies”.

Function 1—FloatAbs(x)

Description.

Returns the absolute (positive) value of a floating point number.

Input.

x—Floating point number of width up to {1, 15, 63}.

Output.

Floating point number of same width as input.

Detailed Description.

Sign

x.Sign=0.

Function 2—FloatNeg(x)

Description.

Returns the negated value of a floating point number.

Input.

x—Floating point number of width up to {1, 15, 63}.

Output.

Floating point number of same width as input.

Detailed Description.

Sign

if Exponent@Mantissa=0.

{

x.Sign=0, Exponent=0, Mantissa=0

}

else

{

x.Sign=!Sign

}

Function 3—FloatLeftShift(x, v)

Description.

Shifts a floating-point number by v places to the left. This macro is equivalent to << for integers.

Input.

x—Floating point number of width up to {1, 15, 63}.

v—Unsigned integer to shift by. This is not larger than ExpWidth.

Output.

Floating point number of same width as input.

Detailed Description.

if Exponent+v>The maximum exponent for the width

{

x=infinity

}

else

{

Exponent

if x=0

{

x=x

}

else

{

x.Exponent=Exponent+v

}

}

Function 4—FloatRightShift(x, v)

Description.

Shifts a floating-point number by v places to the right. This macro is equivalent to >> for integers.

Input.

x—Floating point number of width up to {1, 15, 63}.

v—Unsigned integer to shift by. This is not larger than ExpWidth.

Output.

Floating point number of same width as input.

Detailed Description.

if Exponent—v<The minimum Exponent for the width

{

x=0

}

else

{

Exponent

if x=0

{

x=x

}

else

{

x.Exponent=Exponent−v

}

}

Function 5—FloatRound(x, MantWidth)

Description.

Rounds a floating-point number to one with mantissa width MantWidth.

Input.

x—Floating point number of width up to {1, 15, 63}.

MantWidth—Round to unsigned mantissa width MantWidth.

Output.

Floating point number of same exponent width as input and mantissa width MantWidth.

Dependencies.

RoundUMant—extracts mantissa as an unsigned integer (with hidden 1)

RoundRndMant—Rounds mantissa to MantWidth+2

Detailed Description.

Mantissa

if the next least significant bit and any of the other less significant bits after the cut off point are 1

{

x.Mantissa=The MantWidth most significant bits of Mantissa+1

}

else

{

x.Mantissa=The MantWidth most significant bits of Mantissa

}

Exponent

if Mantissa overflows during rounding

{

x.Exponent=Exponent+1

}

else

{

x.Exponent=Exponent

}

Function 6—FloatConvert(x, ExpWidth, MantWidth)

Description.

Converts a floating-point number to a float of exponent width ExpWidth and mantissa width MantWidth.

Input.

x—Floating point number of width up to {1, 15, 63}.

ExpWidth—Convert to unsigned exponent width ExpWidth.

MantWidth—Convert to unsigned mantissa width MantWidth.

Output.

Floating point number of exponent width ExpWidth and mantissa width MantWidth.

Detailed Description.

if (Exponent−old bias)>new bias

{

x=infinity

}

else

{

Exponent

x.Exponent=Exponent−old bias+new bias

Mantissa

if new width is greater than old width

{

x.Mantissa=Extended mantissa

}

else

{

x.Mantissa=Most significant width bits

}

}

Function 7—FloatMult(x1, x2)

Description.

Multiplies two floating point numbers.

Input.

x1, x2—Folating point numbers of width up to {1, 15, 63}

Output.

Floating point number of same width as input.

Dependencies.

MultUnderflowTest—Tests exponent for underflow.

MultOverflowTest—Tests exponent for overflow.

MultSign—Multipies the Signs.

GetDoubleMantissa—Pads the Mantissa with mantissa width zeros.

MantissaMultOverflow—Tests mantissa for overflow.

AddExponents—Adds exponents.

MultMantissa—Multiplies mantissa and selects the right bits.

Detailed Description.

Test for exponent underflow

if underflow is true {x=0}

else

{

Test for exponent overflow

if overflow is true {x=Infinity}

else

{

Sign

x.Sign=x1.Sign or x2.Sign

Exponent

if mantissa overflows

{

x.Exponent=x1.Exponent+x2.Exponent+1

}

else

{

x.Exponent=x1.Exponent+x2.Exponent

}

Mantissa

Both mantissas are padded below with zeros

Mantissa=x1.Mantissa*x2.Mantissa

x.Mantissa=top input width mantissa bits

}

}

Function 8—FloatAdd(x1, x2)

Description.

Adds two floating point numbers.

Input.

x1, x2—Floating point numbers of width up to {1, 15, 63}.

Output.

Floating point number of same width as input.

Dependencies.

SignedMant—Extracts mantissa as a signed integer.

MaxBiasedExp—determines the greater of two biased exponents.

BiasedExpDiff—Gets the difference between two exponents (to 64).

AddMant—Adds two mantissa.

GetBiasedExp—Gets biased exponent of the result.

GetAddMant—Gets the normalised mantissa of the result.

Detailed Description.

Test for overflow

if number overflows {x=infinity}

else

{

Sign

Adjust the mantissa to have same exponent

Add them

x.Sign=Sign of the result

Exponent

if addition=0

{

x.Exponent=0

}

else

{

x.Exponent=Max Exponent−Amount Mantissa adjusted by

}

Mantissa

Adjust mantissa to have the same exponent

Mantissa=x1.Mantissa+x2.Mantissa

x.Mantissa=top width bits of mantissa

}

Function 9—FloatSub(x1, x2)

Description.

Subtracts one float from another.

Input.

x1, x2—Floating point numbers of width up to {1, 15, 63}.

Output.

Floating point number (x1−x2) of same width as input.

Dependencies.

FloatNeg—Negates number.

FloatAdd—Adds two numbers.

Detailed Description.

x=FloatAdd(x1, −x2)

Function 10—FloatDiv(N, D, Q)

Description.

Divides two floats and outputs the quotient. Q=N/D.

Input.

N, D, Q—Floating point numbers of width up to {1, 15, 63}

Output.

None as it is a macro procedure.

Detailed Description.

This division macro is based on the non-restoring basic division scheme for signed numbers. This scheme has the following routine:

Set s=2 * (1 concatenated to N.Mantissa)

Set d=2 * (1 concatenated to D.mantissa)

Check to see if s is larger than d

If so set exponent adjust to zero

Else s=s/2 and set exponent adjust to one

Then do the following procedure mantissa width+1 times.

Check to see if first digit of (2* s)−d is 0

If so s=(2* s)−d, q=(2* q)+1

Else s=2* s, q=2* q

The quotient Q is then

Q.Sign=N.Sign or D.Sign

Q.Exponent=N.Exponent−D.Exponent+the exponent adjust−1

Q.Mantissa=The least significant mantissa width bits of q

Worked example—dividing 10 by −2.

10=(1.25)*2ˆ 3={0, 0011, 01000}

−2=−(1.0)*2ˆ 1={1, 0001, 00000}

So

s=0010000

d=01000000

Is s larger than d? Yes so

s=00101000

adj_e=1

Iteration 1.

(2* s )−d=01010000−01000000=00010000

The first digit is 0 so

s=00010000

q=1

Iteration 2.

(2* s)−d=00100000−01000000=10100000

The first digit is 1 so

s=00100000

q=10

Iteration 3.

(2* s)−d=01000000−01000000=00000000

The first digit is 0 so

s=00000000

q=101

Iteration 4.

(2* s)−d=00000000−01000000=11000000

The first digit is 1 so

s=00000000

q=1010

Iteration 5.

(2* s)−d=00000000−01000000=11000000

The first digit is 1 so

s=00000000

q=10100

The result is that q ends up as 10100000 after iteration 8.

The quotient Q is then:

Q.Sign=0 or 1=1

Q.Exponent=N.Exponent−D.Exponent+adj_e−1=3−1+1−1=2

Q.Mantissa=01000

So Q is −5 as required.

if D=0

{

Sign=D Sign

Exponent=−1

Mantissa=1

}

else

{

if N Exponent=−1 {Q=N}

else

{

if D Exponent=−1 {Q=D}

else

{

if N=0 {s =0}

else

{

s=(1@N Mantissa<<1)

}

d=(1@N Mantissa<<1)

q=0

i=0

if most significant bit (s-d)=0

{

s=s>>1

adj=1

}

else {adj=0}

while i not equal to width of mantissa+1

{

if most significant bit of (s<<1)−d=

{

s=(s<<1)−d

q=(q<<1)+1

}

else

{

s=s<<1

q=q<<1

}

}

i=i+1

Q Sign=N Sign or D Sign

if q=0

{

Q Exponent=0

}

else {Q Exponent=N Exponent−D Exponent+adj+Bias−1}

Q Mantissa=bottom width bits of q

}

}

}

Function 11—FloatSqrt(R, Q)

Description.

Calculates the square root of the input. Q=Sqrt(R)

Input.

R, Q—Floating point numbers of width up to {1, 15, 63}.

Output.

None as it is a macro procedure.

Dependencies.

GetUnbiasedExp—Extracts unbiased exponent.

Detailed Description.

This square root macro is based on the restoring shift/subtract algorithm. This scheme has the following routine:

Set q=1

Set i=0

Check to see if exponent positive

If so

Set e=R.Exponent/2

Set s=R.Mantissa

Else

Set e=R.Exponent−1

Set s=2* R.Mantissa+2ˆ (mantissa width)

Then do the following procedure mantissa width+1 times.

Check to see if first digit of (2* s)−(4* q+1)*2ˆ (Mantissa width−1−i) is 0

If so s=(2* s)−(4*q+1)*2ˆ (Mantissa width−1−i), q=(2* q)+1

Else s=2* s, q=2* q

The square root Q is then

Q.Sign=0

Q.Exponent=e+bias

Q.Mantissa=The least significant mantissa width bits of q

Worked example—Square rooting 36

36=(1.125)*2ˆ 5={0, 0101, 00100}

So as exponent is odd

e=0010

s=2* mantissa+2ˆ 5=00001000+00100000=00101000

q=1

Iteration 1.

01010000−(00000100+00000001)<<4=00000000

First digit is 0 so

s=00000000

q=11

Iteration 2.

00000000−(00001100−00000001)<<3=10011000

First digit is 1 so

s=00000000

q=110

Iteration 3.

00000000−(00011000−00000001)<<2=10011 100

First digit is 1 so

s=00000000

q=1100

This continues until we have the answer

Q.Sign=0

Q.Exponent=2+bias (in this case bias is 7)

Q.Mantissa=10000

So Q is the integer 6.

if R Sign=1

{

Q Sign=R Sign

Q Exponent=−1

Q Mantissa=2

}

else

{

if R Exponent=−1

{

Q=R

}

else

{

if unbiased exponent even

{

e=(Unbiased exponent)/2

s=R Mantissa

}

else

{

e=(Unbiased exponent−1)/2

s=(R Mantissa<<1)+eˆ width of Q

}

q=2

i=0

while i not equal to width Mantissa+1

{

c=((s<<1)−((4* q+1)<<width mantissa−1−i)

if most significant bit of c=1

{

s=c

q=(q<<1)+1

}

else

{

s=s<<1

q=q<<1

}

i=i+1

}

if R not equal to 0

{

Q Sign=0

Q Exponent=e+bias

Q Mantissa=top width bits of q

}

else {Q=0}

}

}

Function 12—FloatToUInt(x, wi)

Description.

Converts a floating-point number into an unsigned integer of width wi using truncation rounding. If the number is negative a zero is returned.

Input.

x—Floating point number of width up to {1, 15, 63}

wi—unsigned width of unsigned integer

Output.

Unsigned integer of width wi.

Dependencies.

GetMant—Gets mantissa for conversion to integer

ToRoundInt—Rounds to nearest integer

MantissaToInt—Converts mantissa to integer

Detailed Description.

if absolute value of float less than 0.5 or equal to 0

{

Output 0

}

else

{

Left shift mantissa by exponent places

Round to nearest integer

Output (unsigned) integer

}

Function 13—FloatToInt(x, wi)

Description.

Converts a floating point number into a signed integer of width wi using truncation rounding.

Input.

x—floating point number

wi—unsigned width of integer

Output.

Signed integer of width wi.

Dependencies.

GetMant—Gets mantissa for conversion to integer.

ToRoundInt—Rounds to nearest integer.

MantissaToInt—Converts mantissa to integer.

Detailed Description.

if absolute value of float less than 0.5 or equal to 0

{

Output 0

}

else

{

Left shift mantissa by exponent places

Round to nearest integer

if sign=0

{

Output integer

}

else

{

Output—integer

}

}

Function 14—FloatFromUInt(u, ExpWidth, MantWidth)

Description.

Converts an unsigned integer into a floating point number of exponent width ExpWidth and mantissa width MantWidth using truncation rounding.

Input.

u—unsigned integer

ExpWidth—unsigned width of output exponent

MantWidth—unsigned width of output mantissa

Output.

Floating point number of exponent width ExpWidth and mantissa width MantWidth.

Dependencies.

UIntToFloatExp—Gets signed integer to exponent

UIntToFloatNormalised—Gets signed integer to mantissa

Detailed Description.

When finding the left most bit of u the least significant bit is labeled 0 and the label numbering increases as the bits become more significant.

Sign

Sign=most significant binary integer bit

Exponent

if integer=0{Exponent=0}

else {Exponent=position of left most bit+bias}

Mantissa

if integer=0

{

Mantissa=0

}

else

{

if width integer<width mantissa

{

Mantissa=integer<<(width mant−position of left most bit of u)

}

else

}

Mantissa=integer<<(width integer−position of left most bit of u)

}

}

Function 15—FloatFromInt(i, ExpWidth, MantWidth)

Description.

Converts a signed integer into a floating point number of exponent width ExpWidth and mantissa width MantWidth using truncation rounding.

Input.

i—signed integer.

ExpWidth—unsigned width of output exponent

MantWidth—unsigned width of output mantissa

Output.

Floating point number of exponent width ExpWidth and mantissa width MantWidth.

Dependencies.

IntToFloatExp—Gets unsigned integer to exponent

IntToFloatNormalised—Gets unsigned integer to mantissa

Detailed Description.

When finding the left most bit of u the least significant bit is labelled 0 and the label numbering increases as the bits become more significant.

Sign

Sign=most significant integer bit

Exponent

if integer=0 {Exponent=0}

else {Exponent=position of left most bit+bias}

Mantissa

integer=absolute value of integer

if integer=0

{

Mantissa=0

}

else

{

if width integer<width mantissa

{

Mantissa=integer<<(width mant−left most bit of integer)

}

else

{

Mantissa=integer<<(width integer−left most bit of integer)

}

}

Verification

Testing method can be implemented with verification methods such as Positive (Pos), Negative (Neg), Volume and Stress (Vol), Comparison (Comp) and Demonstration (Demo) tests.

Positive Testing

Valid floating point numbers are entered into the macro and the result is compared to the correct answer.

Negative Testing

Invalid floating point numbers are entered into the macro and the resultant error is compared to the correct error.

Volume and Stress Testing

Valid floating point numbers are repeatedly entered into the macro to see that it works in a correct and repeatable manner.

Comparison Testing

Correct results are gained from a reliable source to compare the macro results to.

Demonstration Testing

Behavior in representative circumstances is evaluated.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for improved efficiency during the execution of floating point applications, comprising the steps of:
(a) providing a floating point application written using a floating point library, and
(b) constructing hardware based on the floating point application;
(c) wherein computer code of the floating point application shares components selected from the group consisting of multipliers, dividers, adders and subtractors for minimizing an amount of the hardware to be constructed.

2. A method as recited in claim 1, wherein the components are used on a single clock cycle.

3. A method as recited in claim 1, wherein the floating point library includes macros for arithmetic functions.

4. A method as recited in claim 1, wherein the floating point library includes macros for integer to floating point conversions.

5. A method as recited in claim 1, wherein the floating point library includes macros for floating point to integer conversions.

6. A method as recited in claim 1, wherein the floating point library includes macros for a square root function.

7. A method as recited in claim 1, wherein a width of the output of the computer code is user-specified.

8. A method as recited in claim 1, wherein the computer code is programmed using Handel-C.

9. A computer program product for improved efficiency during the execution of floating point applications, comprising:
(a) computer code for providing a floating point application written using a floating point library; and
(b) computer code for constructing hardware based on the floating point application;
(c) wherein computer code of the floating point application shares components selected from the group consisting of multipliers, dividers, adders and subtractors for minimizing an amount of the hardware to be constructed.

10. A computer program product as recited in claim 9, wherein the components are used on a single clock cycle.

11. A computer program product as recited in claim 9, wherein the floating point library includes macros for arithmetic functions.

12. A computer program product as recited in claim 9, wherein the floating point library includes macros for integer to floating point conversions.

13. A computer program product as recited in claim 9, wherein the floating point library includes macros for floating point to integer conversions.

14. A computer program product as recited in claim 9, wherein the floating point library includes macros for a square root function.

15. A computer program product as recited in claim 9, wherein a width of the output of the computer code is user-specified.

16. A computer program product as recited in claim 9, wherein the computer code is programmed using Handel-C.

17. A system for improved efficiency during the execution of floating point applications, comprising:
(a) logic for providing a floating point application written using a floating point library; and
(b) logic for constructing hardware based on the floating point application;
(c) wherein computer code of the floating point application components selected from the group consisting of multipliers, dividers, adders and subtractors for minimizing an amount of the hardware to be constructed.
